(19) United States
(12) Patent Application Publication
(10) Pub. No.: US 2015/0302856 A1
(43) Pub. Date: Oct. 22, 2015

(54) METHOD AND APPARATUS FOR PERFORMING FUNCTION BY SPEECH INPUT

(71) Applicant: QUALCOMM Incorporated, San Diego, CA (US)

(72) Inventors: Taesu Kim, Suwon (KR); Minho Jin, Seoul (KR); Juncheol Cho, Seoul (KR)

(21) Appl. No.: 14/466,580

(22) Filed: Aug. 22, 2014

Related U.S. Application Data
(60) Provisional application No. 61/980,889, filed on Apr. 17, 2014.

(51) Int. Cl. G10L 17/22; G10L 25/48

(52) U.S. Cl. CPC G10L 17/22; G10L 25/48

(57) ABSTRACT

A method for performing a function in an electronic device is disclosed. The method may include receiving an input sound stream including a speech command indicative of the function and identifying the function from the speech command in the input sound stream. Further, the method may determine a security level associated with the speech command. It may be verified whether the input sound stream is indicative of a user authorized to perform the function based on the security level. In response to verifying that the input sound stream is indicative of the user, the function may be performed.

### CROSS-REFERENCE TO RELATED APPLICATION(S)

This application is based upon and claims the benefit of priority from U.S. Provisional Patent Application No. 61/980,889, filed on Apr. 17, 2014, the entire contents of which are incorporated herein by reference.

### TECHNICAL FIELD

The present disclosure relates generally to performing a function in an electronic device, and more specifically, to verifying a speaker of a speech input to perform a function in an electronic device.

### BACKGROUND

Recently, the use of electronic devices such as smartphones, tablet computers, and wearable computers has been increasing among consumers. These devices may provide a variety of capabilities such as data processing and communication, voice communication, Internet browsing, multimedia playing, game playing, etc. In addition, such electronic devices may include a variety of applications capable of performing various functions for users.

For user convenience, conventional electronic devices often include a speech recognition function to recognize speech from users. In such electronic devices, a user may speak a voice command to perform a specified function instead of manually navigating through an I/O device such as a touch screen or a keyboard. The voice command from the user may then be recognized and the specified function may be performed in the electronic devices.

Some applications or functions in an electronic device may include personal or private information of a user. In order to provide security for such personal or private information, the electronic device may limit access to the applications or functions. For example, the electronic device may request a user to input identification information such as a personal identification number (PIN), a fingerprint, or the like, and access to the applications or functions may be allowed based on the identification information. However, such input of the identification information may require manual operation from the user through the use of a touch screen, a button, an image sensor, or the like, thereby resulting in user inconvenience.

### SUMMARY

The present disclosure provides methods and apparatus for receiving a speech command and performing a function associated with the speech command based on a security level associated with the speech command.

According to one aspect of the present disclosure, a method for performing a function in an electronic device is disclosed. The method may include receiving an input sound stream including a speech command indicative of the function and identifying the function from the speech command in the input sound stream. Further, the method may determine a security level associated with the speech command. It may be verified whether the input sound stream is indicative of a user authorized to perform the function based on the security level. In response to verifying that the input sound stream is indicative of the user, the function may be performed. This disclosure also describes an apparatus, a device, a system, a combination of means, and a computer-readable medium relating to this method.

According to another aspect of the present disclosure, an electronic device for performing a function is disclosed. The electronic device may include a sound sensor configured to receive an input sound stream including a speech command indicative of the function and a speech recognition unit configured to identify the function from the speech command in the input sound stream. The electronic device may further include a security management unit configured to verify whether the input sound stream is indicative of a user authorized to perform the function based on a security level associated with the speech command. In response to verifying that the input sound stream is indicative of the user, a function control unit in the electronic device may perform the function.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates a mobile device that performs a function of a voice assistant application in response to an activation keyword and a speech command in an input sound stream, according to one embodiment of the present6 disclosure.

FIG. 2 illustrates a block diagram of an electronic device configured to perform a function based on a security level assigned to the function, according to one embodiment of the present disclosure.

FIG. 3 illustrates a detailed block diagram of a voice activation unit in the electronic device that is configured to activate a voice assistant unit by detecting an activation keyword and verifying a speaker of the activation keyword as an authorized user, according to one embodiment of the present disclosure.

FIG. 4 illustrates a detailed block diagram of the voice assistant unit in the electronic device that is configured to perform a function in response to a speech command based on a security level associated with the speech command, according to one embodiment of the present disclosure.

FIG. 5 illustrates a flowchart of a method for performing a function in the electronic device based on a security level associated with a speech command, according to one embodiment of the present disclosure.

FIG. 6 illustrates a flowchart of a detailed method for activating a voice assistant unit by determining a keyword score and a verification score for an activation keyword, according to one embodiment of the present disclosure.

FIG. 7 illustrates a flowchart of a detailed method for performing a function associated with a speech command according to a security level associated with the speech command, according to one embodiment of the present disclosure.

FIG. 8 illustrates a flowchart of a detailed method for performing a function in an electronic device when a security level associated with a speech command is determined to be an intermediate security level, according to one embodiment of the present disclosure.

FIG. 9 illustrates a flowchart of a detailed method for performing a function in an electronic device when a security level associated with a speech command is determined to be a high security level, according to one embodiment of the present disclosure.

FIG. 10 illustrates a flowchart of a detailed method for performing a function in an electronic device based on upper and lower verification thresholds for a speech command when a security level associated with the speech command is determined to be a high security level, according to one embodiment of the present disclosure.

FIG. 11 illustrates a plurality of lookup tables, in which a plurality of security levels associated with a plurality of functions is adjusted in response to changing a device security level for an electronic device, according to one embodiment of the present disclosure.

FIG. 12 is a block diagram of an exemplary electronic device in which the methods and apparatus for performing a function of a voice assistant unit in response to an activation keyword and a speech command in an input sound stream may be implemented according to some embodiments of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

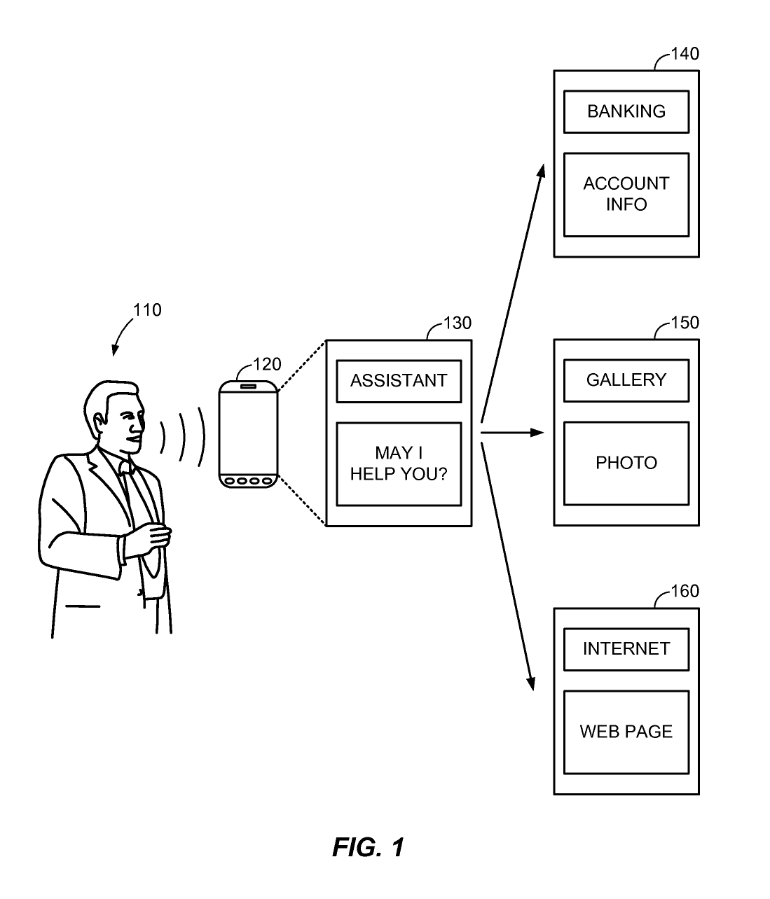

FIG. 1 illustrates a mobile device 120 that performs a function of a voice assistant application 130 in response to an activation keyword and a speech command in an input sound stream, according to one embodiment of the present disclosure. Initially, the mobile device 120 may store an activation keyword for activating the voice assistant application 130 in the mobile device 120. In the illustrated embodiment, when a speaker 110 speaks the activation keyword such as “HEY ASSISTANT” to the mobile device 120, the mobile device 120 may capture an input sound stream and detect the activation keyword in the input sound stream. As used herein, the term “sound stream” may refer to a sequence of one or more sound signals or sound data, and may include analog, digital, and acoustic signals or data.

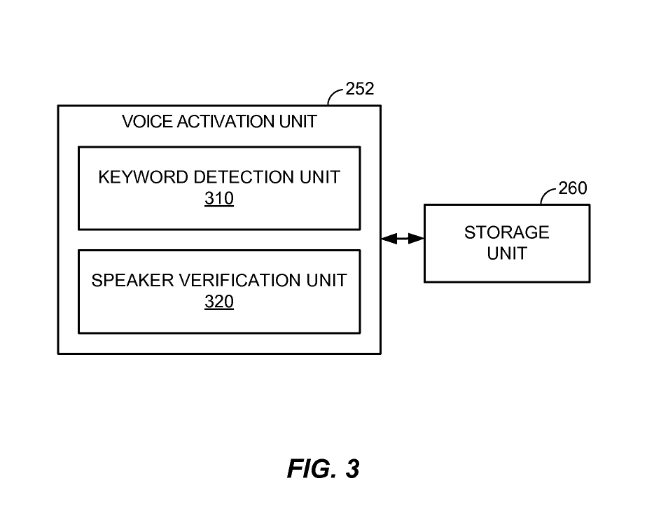

Upon detecting the activation keyword, the mobile device 120 may activate the voice assistant application 130. In one embodiment, the mobile device 120 may verify whether the speaker 110 of the activation keyword is indicative of a user authorized to activate the voice assistant application 130, as will be described below in more detail with reference to FIG. 3. For example, the mobile device 120 may verify the speaker 110 to be the authorized user based on a speaker model of the authorized user. The speaker model may be a model representing sound characteristics of the authorized user and may be a statistical model of such sound characteristics. In this embodiment, upon verifying the speaker 110 of the activation keyword as the authorized user, the mobile device 120 may activate the voice assistant application 130.

In the illustrated embodiment, the speaker 110 may speak a speech command associated with a function which may be performed by the activated voice assistant application 130. The voice assistant application 130 may be configured to perform any suitable number of functions. For example, such functions may include accessing, controlling, and managing various applications (e.g., a banking application 140, a photo application 150, and a web browser application 160) in the mobile device 120. The functions may be configured with a plurality of different security levels. According to some embodiments, the security levels may include a high security level, a low security level, and an intermediate security level between the high security level and the low security level. Each function may be assigned one of the security levels according to a level of security which the function requires. For example, the banking application 140, the photo application 150, and the web browser application 160 may be assigned a high security level, an intermediate security level, and a low security level, respectively. The security levels may be assigned to the applications 140, 150, and 160 by a manufacturer and/or a user of the mobile device 120.

In FIG. 1, the speaker 110 may speak “I WANT TO CHECK MY BANK ACCOUNT,” “PLEASE SHOW MY PHOTOS,” or “OPEN WEB BROWSER” as a speech command for activating the banking application 140, the photo application 150, or the web browser application 160, respectively. In response, the mobile device 120 may receive the input sound stream which includes the speech command spoken by the speaker 110. From the received input sound stream, the activated voice assistant application 130 may recognize the speech command. According to one embodiment, the mobile device 120 may buffer a portion of the input sound stream in a buffer memory of the mobile device 120 in response to detecting the activation keyword. In this embodiment, at least a portion of the speech command in the input sound stream may be buffered in the buffer memory, and the voice assistant application 130 may recognize the speech command from the buffered portion of the input sound stream.

Once the speech command is recognized, the voice assistant application 130 may identify the function associated with the speech command (e.g., activating the banking application 140, the photo application 150, or the web browser application 160). Additionally, the voice assistant application 130 may determine the security level associated with the speech command (e.g., a high security level, an intermediate security level, or a low security level). For example, the security level assigned to the function may be determined using a lookup table or any suitable data structure, which maps each function to an associated security level.

According to one embodiment, the security level may be determined based on a context of the speech command. In this embodiment, the speech command may be analyzed to recognize one or more words in the speech command, and the recognized words may be used to determine the security level associated with the speech command. For example, if a word “BANKING” is recognized from a speech command in an input sound stream, the voice assistant application 130 may determine that such a word relates to applications requiring protection of private information, and thus, assign a high security level as a security level associated with the speech command based on the recognized word. On the other hand, if a word “WEB” is recognized from a speech command, the voice assistant application 130 may determine that such a word relates to applications searching for public information, and thus, assign a low security level as a security level associated with the speech command.

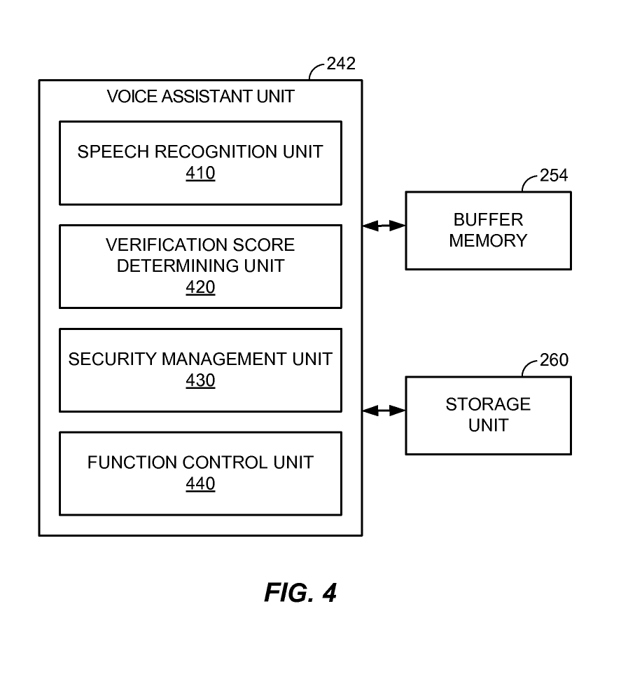

The voice assistant application 130 may perform the function associated with the speech command based on the determined security level, as will be described below in more detail with reference to FIG. 4. For example, in the case of the function for activating the web browser application 160 which is assigned a low security level, the voice assistant application 130 may activate the web browser application 160 without an additional speaker verification process. On the other hand, for the function of activating the photo application 150 which is assigned an intermediate security level, the voice assistant application 130 may verify whether the speaker 110 of the speech command is the authorized user based on the speech command in the input sound stream. Additionally, for the function of activating the banking application 140 which is assigned a high security level, the voice assistant application 130 may optionally request the speaker 110 to input additional verification information.

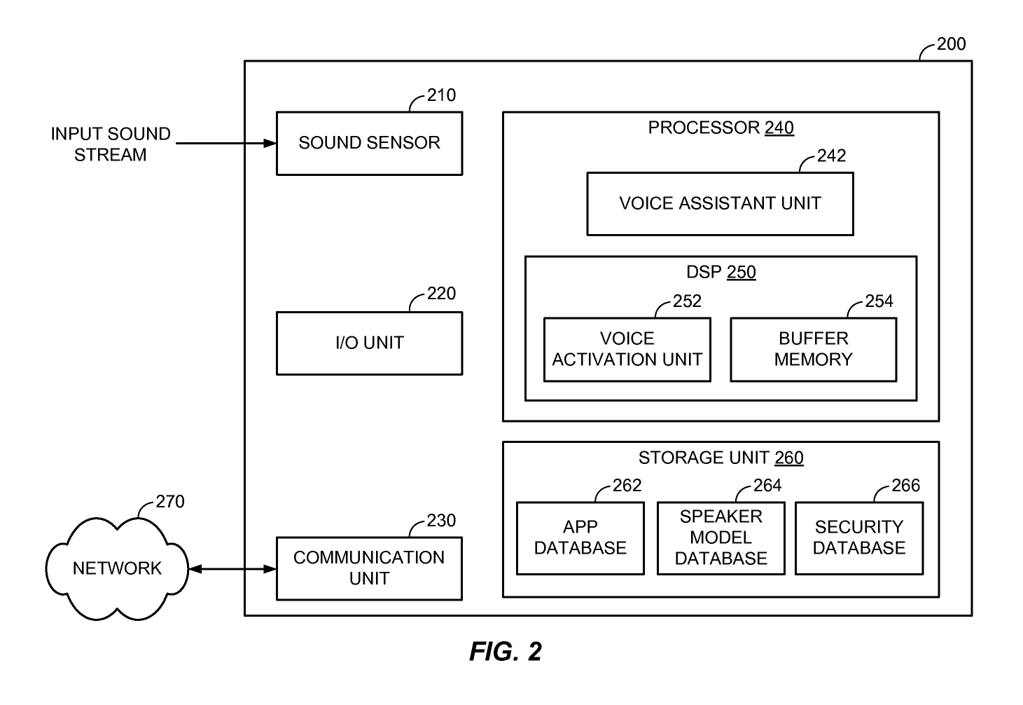

FIG. 2 illustrates a block diagram of an electronic device 200 configured to perform a function based on a security level assigned to the function, according to one embodiment of the present disclosure. The electronic device 200 may include a sound sensor 210, an I/O (input/output) unit 220, a communication unit 230, a processor 240, and a storage unit 260. The electronic device 200 may be any suitable device equipped with sound capturing and processing capabilities such as a cellular phone, a smartphone (e.g., the mobile device 120), a personal computer, a laptop computer, a tablet computer, a smart television, a gaming device, a multimedia player, smart glasses, a wearable computer, etc.

The processor 240 may be an application processor (AP), a central processing unit (CPU), or a microprocessor unit (MPU) for managing and operating the electronic device 200 and may include a voice assistant unit 242 and a digital signal processor (DSP) 250. The DSP 250 may include a voice activation unit 252 and a buffer memory 254. In one embodiment, the DSP 250 may be a low power processor for reducing power consumption in processing sound streams. In this configuration, the voice activation unit 252 in the DSP 250 may be configured to activate the voice assistant unit 242 in response to detecting an activation keyword in an input sound stream. According to one embodiment, the voice activation unit 252 may activate the processor 240, which in turn may activate the voice assistant unit 242. As used herein, the term “activation keyword” may refer to one or more words adapted to activate the voice assistant unit 242 for performing a function in the electronic device 200, and may include a phrase of two or more words such as an activation key phrase. For example, an activation key phrase such as “HEY ASSISTANT” may be an activation keyword that may activate the voice assistant unit 242.

The storage unit 260 may include an application database 262, a speaker model database 264, and a security database 266 that can be accessed by the processor 240. The application database 262 may include any suitable applications of the electronic device 200 such as a voice assistant application, a banking application, a photo application, a web browser application, an alarm application, a messaging application, and the like. In one embodiment, the voice activation unit 252 may activate the voice assistant unit 242 by accessing the application database 262 and loading and launching the voice assistant application from the application database 262. Although the voice activation unit 252 is configured to activate the voice assistant unit 242 (or load and launch the voice assistant application) in the illustrated embodiment, it may also activate any other units (or load and launch any other applications) of the electronic device 200 that may be associated with one or more activation keywords.

The speaker model database 264 in the storage unit 260 may include one or more speaker models for use in verifying whether a speaker is an authorized user, as will be described below in more detail with reference to FIGS. 3 and 4. The security database 266 may include security information associated with a plurality of security levels for use in verifying whether a speaker is an authorized user. For example, the security information may include a plurality of verification thresholds associated with the plurality of security levels, as will be described below in more detail with reference to FIGS. 3 and 4. The storage unit 260 may be implemented using any suitable storage or memory devices such as a RAM (Random Access Memory), a ROM (Read-Only Memory), an EEPROM (Electrically Erasable Programmable Read-Only Memory), a flash memory, or an SSD (Solid State Drive).

The sound sensor 210 may be configured to receive an input sound stream and provide the received input sound stream to the DSP 250. The sound sensor 210 may include one or more microphones or other types of sound sensors that can be used to receive, capture, sense, and/or detect sound. In addition, the sound sensor 210 may employ any suitable software and/or hardware to perform such functions.

In order to reduce power consumption, the sound sensor 210 may be configured to receive the input sound stream periodically according to a duty cycle. For example, the sound sensor 210 may operate on a 10% duty cycle such that the input sound stream is received 10% of the time (e.g., 20 ms in a 200 ms period). In this case, the sound sensor 210 may detect sound by determining whether a received portion of the input sound stream exceeds a predetermined threshold sound intensity. For example, a sound intensity of the received portion of the input sound stream may be determined and compared with the predetermined threshold sound intensity. If the sound intensity of the received portion exceeds the threshold sound intensity, the sound sensor 210 may disable the duty cycle function to continue receiving a remaining portion of the input sound stream. In addition, the sound sensor 210 may activate the DSP 250 and provide the received portion of the input sound stream including the remaining portion to the DSP 250.

When the DSP 250 is activated by the sound sensor 210, the voice activation unit 252 may be configured to continuously receive the input sound stream from the sound sensor 210 and detect an activation keyword (e.g., “HEY ASSISTANT”) in the received input sound stream to activate the voice assistant unit 242. In order to detect the activation keyword, the voice activation unit 252 may employ any suitable keyword detection methods based on a Markov chain model such as a hidden Markov model (HMM), a semi-Markov model (SMM), or a combination thereof. Once the activation keyword is detected, the voice activation unit 252 may activate the voice assistant unit 242 to recognize a speech command in the input sound stream. In some embodiments, in response to detecting the activation keyword, a plurality of microphones in the sound sensor 210 may be activated to receive and pre-process the input sound stream. For example, the pre-processing may include noise suppression, noise cancelling, dereverberation, or the like, which may result in robust speech recognition in the voice assistant unit 242 against environmental variations.

According to one embodiment of the present disclosure, the voice activation unit 252 may verify whether a speaker of the activation keyword in the input sound stream is indicative of a user authorized to activate the voice assistant unit 242. The speaker model database 264 may include a speaker model, which is generated for the activation keyword, for use in the verification process. For example, the speaker model may be a text-dependent model that is generated for a predetermined activation keyword. If the voice activation unit 252 verifies the speaker as the authorized user based on the speaker model for the activation keyword, the voice activation unit 252 may activate the voice assistant unit 242. The voice activation unit 252 may generate an activation signal and the voice assistant unit 242 may be activated in response to the activation signal.

Once activated, the voice assistant unit 242 may be configured to recognize a speech command in the input sound stream. As used herein, the term “speech command” may refer to one or more words uttered from a speaker indicative of a function that may be performed by the voice assistant unit 242, such as “I WANT TO CHECK MY BANK ACCOUNT,” “PLEASE SHOW MY PHOTOS,” “OPEN WEB BROWSER,” and the like. The voice assistant unit 242 may receive a portion of the input sound stream including the speech command from the sound sensor 210, and recognize the speech command from the received portion of the input sound stream. Although the terms “voice assistant unit” (e.g., voice assistant unit 242) and “voice assistant application” are used above to describe a function for recognizing a speech command, other suitable terms such as a speech recognition unit, speech recognition application or function may be interchangeably used to refer to the same function in some embodiments.

In one embodiment, the voice activation unit 252 may be configured to, in response to detecting the activation keyword, buffer (or temporarily store) a portion of the input sound stream being received from the sound sensor 210 in the buffer memory 254 of the DSP 250. In this embodiment, the buffered portion may include at least a portion of the speech command in the input sound stream. To recognize the speech command, the voice assistant unit 242 may access the buffer memory 254. The buffer memory 254 may be implemented using any suitable storage or memory schemes in a processor such as a local memory or a cache memory. Although the DSP 250 includes the buffer memory 254 in the illustrated embodiment, the buffer memory 254 may be implemented as a memory area in the storage unit 260. In some embodiments, the buffer memory 254 may be implemented using a plurality of physical memory areas or a plurality of logical memory areas.

When the speech command is recognized, the voice assistant unit 242 may identify a function associated with the speech command and determine a security level associated with the speech command In one embodiment, the voice assistant unit 242 may determine a security level assigned to the identified function as the security level associated with the speech command. In this embodiment, the security database 266 may include information which maps a plurality of functions to be performed by the voice assistant unit 242 to a plurality of predetermined security levels. The voice assistant unit 242 may access the security database 266 to determine the security level assigned to the identified function. In another embodiment, the voice assistant unit 242 may determine the security level associated with the speech command based on one or more words recognized from the speech command in such a manner as described above.

Once the security level is determined, the voice assistant unit 242 may perform the function based on the security level. When the security level is a security level which requires speaker verification (e.g., an intermediate security level or a high security level as described above with reference to FIG. 1), the voice assistant unit 242 may verify whether a speaker of the speech command is a user authorized to perform the function based on the speech command in the input sound stream and optionally request the speaker to input additional verification information, as will be described below in more detail with reference to FIG. 4. In this case, the voice assistant unit 242 may perform the function when the speaker is verified as the authorized user.

In some embodiments, a duration of the speech command may be greater than that of the activation keyword. In addition, more power and computational resources may be provided for the voice assistant unit 242 than the voice activation unit 252. Accordingly, the voice assistant unit 242 may perform the speaker verification in a more confident and accurate manner than the voice activation unit 252.

The I/O unit 220 and the communication unit 230 may be used in the process of performing the function. For example, when the function associated with the speech command is an Internet search function, the voice assistant unit 242 may perform a web search via the communication unit 230 through a network 270. In this case, search results for the speech command may be output on a display screen of the I/O unit 220.

FIG. 3 illustrates a detailed block diagram of the voice activation unit 252 which is configured to activate the voice assistant unit 242 by detecting an activation keyword and verifying a speaker of the activation keyword as an authorized user, according to one embodiment of the present disclosure. The voice activation unit 252 may include a keyword detection unit 310 and a speaker verification unit 320. As illustrated, the voice activation unit 252 may be configured to access the storage unit 260.

The voice activation unit 252 may receive an input sound stream from the sound sensor 210, and the keyword detection unit 310 may detect the activation keyword in the received input sound stream. In order to detect the activation keyword, the keyword detection unit 310 may employ any suitable keyword detection method based on an HMM, an SMM, or the like. According to one embodiment, the storage unit 260 may store a plurality of words for the activation keyword. Additionally, the storage unit 260 may store state information on a plurality of states associated with a plurality of portions of the words. For example, each of the words for the activation keywords and speech commands may be divided into a plurality of basic units of sound such as phones, phonemes, or subunits thereof, and a plurality of portions of each of the words may be generated based on the basic units of sound. Each portion of each of the words may then be associated with a state under a Markov chain model such as an HMM, an SMM, or a combination thereof.

As the input sound stream is received, the keyword detection unit 310 may extract a plurality of sound features (e.g., audio fingerprints or MFCC (Mel-frequency cepstral coefficients) vectors) from the received portion of the input sound stream. The keyword detection unit 310 may then determine a plurality of keyword scores for the plurality of sound features, respectively, by using any suitable probability models such as a Gaussian mixture model (GMM), a neural network, a support vector machine (SVM), and the like. The keyword detection unit 310 may compare each of the keyword scores with a predetermined keyword detection threshold for the activation keyword and when one of the keyword scores exceeds the keyword detection threshold, the activation keyword may be detected from the received portion of the input sound stream. In some embodiments, a remaining portion of the input sound stream which is subsequent to the portion of the input sound stream including the activation keyword may be buffered in the buffer memory 254 for use in recognizing a speech command from the input sound stream.

Additionally, the speaker verification unit 320 may verify whether a speaker of the activation keyword is indicative of a user authorized to activate the voice assistant unit 242. In this case, the speaker model database 264 in the storage unit 260 may include a speaker model of the authorized user. The speaker model may be generated based on a plurality of sound samples of the activation keyword which is spoken by the authorized user. For example, the speaker model may be a text-dependent model that is generated for the activation keyword. In some embodiments, the speaker model may be a GMM model including statistical data such as a mean and a variance for the sound samples. Additionally, the speaker model may also include a maximum value, a minimum value, a noise power, an SNR, a signal power, an entropy, a kurtosis, a high order momentum, etc. of the sound samples.

The speaker verification unit 320 may determine a verification score for the activation keyword based on the extracted sound features and the speaker model in the speaker model database 264. The verification score for the activation keyword may then be compared with a verification threshold associated with the activation keyword. The verification threshold may be predetermined and pre-stored in the storage unit 260 (e.g., the security database 266). If the verification score exceeds the verification threshold, the speaker of the activation keyword may be verified as the authorized user. In this case, the voice activation unit 252 may activate the voice assistant unit 242. On the other hand, if the speaker is not verified as the authorized user, the mobile device 120 may proceed to receive a next input sound stream for detecting the activation keyword.

FIG. 4 illustrates a detailed block diagram of the voice assistant unit 242 configured to perform a function in response to a speech command based on a security level associated with the speech command, according to one embodiment of the present disclosure. The voice assistant unit 242 may include a speech recognition unit 410, a verification score determining unit 420, and a security management unit 430, and a function control unit 440. As illustrated, the voice assistant unit 242 may be configured to access the buffer memory 254 and the storage unit 260.

When the voice assistant unit 242 is activated by the voice activation unit 252, the voice assistant unit 242 may receive at least a portion of the input sound stream including the speech command from the sound sensor 210. The buffer memory 254 may store the portion of the input sound stream including the speech command. Upon receiving the input sound stream, the speech recognition unit 410 may recognize the speech command from the received portion of the input sound stream. In some embodiments, the speech recognition unit 410 may access the portion of the input sound stream including the speech command from the buffer memory 254 and recognize the speech command using any suitable speech recognition methods based on an HMM, an SMM, or the like.

Upon recognizing the speech command, the speech recognition unit 410 may identify the function associated with the speech command such as activating an associated application (e.g., a banking application, a photo application, a web browser application, or the like). In one embodiment, the speech recognition unit 410 may provide the identified function to the security management unit 430. In response, the security management unit 430 may determine a security level associated with the function. To identify the function and determine the security level, the speech recognition unit 410 and the security management unit 430 may access the storage unit 260. In another embodiment, the speech recognition unit 410 may provide the recognized speech command to the security management unit 430, which may determine the security level of the function associated with the speech command by accessing the storage unit 260.

According to some embodiments, the security level may be determined based on a context of the speech command. In this case, the speech recognition unit 410 may provide the recognized speech command to the security management unit 430. Upon receiving the speech command from the speech recognition unit 410, the security management unit 430 may determine the security level based on the context of the received speech command. In one embodiment, the security database 266 in the storage unit 260 may include a lookup table or any suitable data structure which maps predetermined words, phrases, sentences, or combinations thereof to a plurality of predetermined security levels. In this embodiment, the security management unit 430 may access the security database 266 and use the received speech command as an index to search the lookup table for the security level associated with the speech command.

Once the security level is determined, the voice assistant unit 242 may perform the function based on the security level. The security level may indicate whether or not the security level requires speaker verification for performing the function. For example, when the determined security level does not require speaker verification as in a case of a low security level associated with a function of activating a web browser application in the electronic device 200, the voice assistant unit 242 may perform the function without performing a speaker verification process. In one embodiment, the security management unit 430 may instruct the function control unit 440 to generate a signal for performing the function.

On the other hand, when the security level requires speaker verification, the voice assistant unit 242 may perform the associated function when a speaker of the speech command is verified as a user authorized to perform the function. In some embodiments, an intermediate security level between the low security level and a high security level may require the speaker of the speech command to be verified. For example, the intermediate security level may be associated with a function of activating a photo application in the electronic device 200. In this case, the security management unit 430 may output a signal instructing the verification score determining unit 420 to determine a verification score for the speech command in the input sound stream.

The verification score determining unit 420 may determine the verification score for the speech command by accessing the speaker model database 264 that includes a speaker model for the speech command. The verification score determining unit 420 may then provide the verification score to the security management unit 430, which may compare the verification score for the speech command with a verification threshold associated with the intermediate security level. In some embodiments, the security database 266 may include the verification threshold associated with the intermediate security level. If the verification score exceeds the verification threshold, the speaker of the speech command is verified to be the authorized user and the voice assistant unit 242 may perform the function associated with the speech command In one embodiment, the function control unit 440 may generate a signal for performing the function. On the other hand, if the verification score does not exceed the verification threshold, the speaker is not verified as the authorized user and the associated function is not performed.

In some embodiments, the security management unit 430 may determine that the security level associated with the speech command is a high security level. In this case, the security management unit 430 may request an additional user input to verify the speaker of the speech command. For example, the high security level may be associated with a function of activating a banking application in the electronic device 200. Upon determining a high security level, the security management unit 430 may instruct the verification score determining unit 420 to determine a verification score for the speech command The security management unit 430 may receive the verification score from the verification score determining unit 420 and compare the verification score with an upper verification threshold associated with the high security level by accessing the security database 266 including the upper verification threshold. In one embodiment, the upper verification threshold associated with the high security level may be set to be higher than the verification threshold associated with the intermediate security level. If the verification score exceeds the upper verification threshold, the voice assistant unit 242 (or the function control unit 440) may perform the function associated with the speech command

On the other hand, if the verification score does not exceed the upper verification threshold associated with the high security level, the security management unit 430 may compare the verification score with a lower verification threshold associated with the high security level by accessing the security database 266 including the lower verification threshold. If the verification score does not exceed the lower verification threshold associated with the high security level, the function associated with the speech command is not performed. If the verification score exceeds the lower verification threshold associated with the high security level, the security management unit 430 may request the speaker of the speech command for an additional input to verify the speaker.

In some embodiments, the additional input for verifying the speaker may include a verification keyword. As used herein, the term “verification keyword” may refer to one or more predetermined words for verifying a speaker as a user authorized to perform the function of the speech command, and may include a phrase of two or more words such as a verification pass phrase. For example, the verification keyword may be personal information such as a name, a birthday, or a personal identification number (PIN) of an authorized user. The verification keyword may be predetermined and included in the security database 266.

When the speaker speaks the verification keyword, the voice assistant unit 242 may receive the verification keyword in the input sound stream via the sound sensor 210. The speech recognition unit 410 may then detect the verification keyword from the input sound stream using any suitable keyword detection methods. In some embodiments, the voice assistant unit 242 may also include any suitable unit (e.g., a keyword detection unit) configured to detect the verification keyword. By detecting the verification keyword from the input sound stream, which may be personal information of the authorized user such as a name, a birthday, or a PIN, the speaker may be verified as the authorized user for the function.

Upon detecting the verification keyword, the verification score determining unit 420 may determine a verification score for the verification keyword and provide the verification score to the security management unit 430, which may compare the verification score with a verification threshold associated with the verification keyword. In some embodiments, the security database 266 may include the verification threshold associated with the verification keyword. If the verification score exceeds the verification threshold for the verification keyword, the voice assistant unit 242 (or the function control unit 440) may perform the function associated with the speech command. On the other hand, if the verification score does not exceed the verification threshold for the verification keyword, the function is not performed.

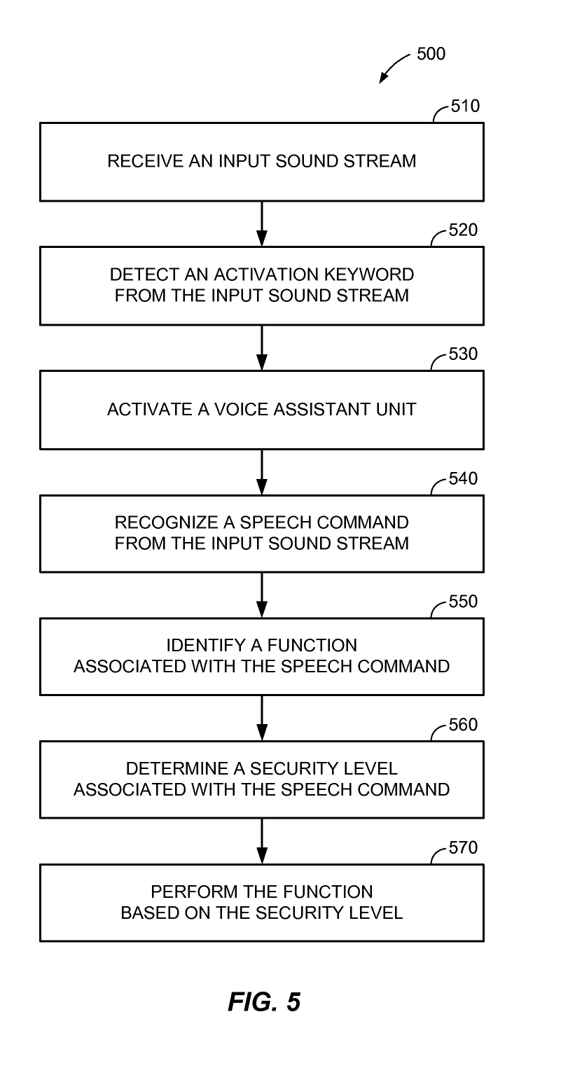

FIG. 5 illustrates a flowchart of a method 500 for performing a function in the electronic device 200 based on a security level associated with a speech command, according to one embodiment of the present disclosure. The electronic device 200 may receive an input sound stream including an activation keyword for activating the voice assistant unit 242 and the speech command for performing the function by the voice assistant unit 242, at 510. In response to receiving the input sound stream, the voice activation unit 252 may detect the activation keyword from the input sound stream, at 520. When the activation keyword is detected from the input sound stream, the voice activation unit 252 may activate the voice assistant unit 242, at 530. In one embodiment, the voice activation unit 252 may be configured to verify whether a speaker of the activation keyword is indicative of a user authorized to activate the voice assistant unit 242 and when the speaker is verified to be the authorized user, the voice activation unit 252 may activate the voice assistant unit 242.

The activated voice assistant unit 242 may recognize the speech command from the input sound stream, at 540. From the recognized speech command, the voice assistant unit 242 may identify the function associated with the speech command, at 550. In some embodiments, the storage unit 260 may store a lookup table or any suitable data structure, which maps one or more words in the speech command to a specified function. To identify the function, the voice assistant unit 242 may use any suitable word in the speech command as an index for searching the lookup table or data structure.

In addition, the voice assistant unit 242 may determine the security level associated with the speech command, at 560. In some embodiments, the security database 266 in the storage unit 260 may include a lookup table or any suitable data structure, which maps each function to a security level (e.g., a low security level, an intermediate security level, or a high security level). To determine the security level of the function, the voice assistant unit 242 may search the security database 266 with the identified function as an index. Additionally or alternatively, the security database 266 may include a lookup table or any suitable data structure, which maps predetermined words, phrases, sentences, or combinations thereof in a speech command to a plurality of predetermined security levels. In this case, the voice assistant unit 242 may access the security database 266 using the recognized speech command as an index to determine the security level associated with the speech command.

In the illustrated embodiment, the function associated with the speech command is identified before the security level associated with the speech command is determined However, the process of identifying the function may be performed after the process of determining the security level based on the recognized speech command, or concurrently with the process of determining the security level. Once the function is identified and the security level is determined, the voice assistant unit 242 may perform the function based on the security level, at 570, according to the manner as described above with reference to FIG. 4.

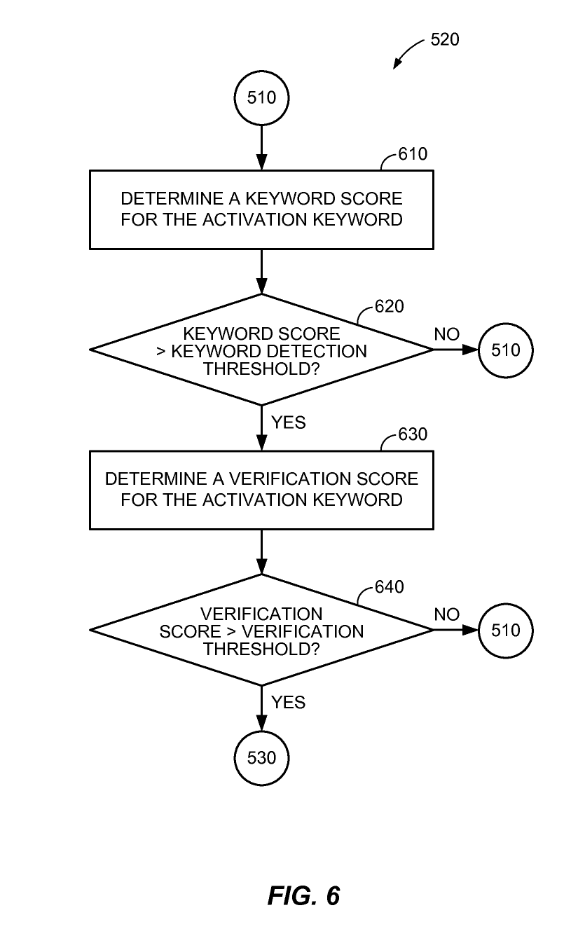

FIG. 6 illustrates a flowchart of a detailed method of 520 for activating the voice assistant unit 242 by determining a keyword score and a verification score for the activation keyword, according to one embodiment of the present disclosure. Once the input sound stream is received, at 510, the voice activation unit 252 may determine the keyword score for the activation keyword, at 610. Any suitable probability models such as a GMM, a neural network, an SVM, and the like may be used for determining the keyword score. The voice activation unit 252 may compare the keyword score with a predetermined keyword detection threshold for the activation keyword, at 620. If the keyword score is determined not to exceed the keyword detection threshold (i.e., NO at 620), the voice assistant unit 242 is not activated and the method may proceed to 510 in FIG. 5 to receive a next input sound stream.

On the other hand, the keyword score for the activation keyword is determined to exceed the keyword detection threshold for the activation keyword (i.e., YES at 620), the voice activation unit 252 may determine a verification score for the activation keyword, at 630. The verification score may be determined based on a speaker model of an authorized user, which may be a text-dependent model generated for the activation keyword. The verification score for the activation keyword may be compared with a verification threshold associated with the activation keyword, at 640. If the verification score is determined not to exceed the verification threshold (i.e., NO at 640), the voice assistant unit 242 is not activated and the method may proceed to 510 in FIG. 5 to receive a next input sound stream. On the other hand, the verification score is determined to exceed the verification threshold (i.e., YES at 640), the method may proceed to 530 to activate the voice assistant unit 242.

In some embodiments, once the keyword score is determined to exceed the keyword detection threshold, at 620, the voice activation unit 252 may activate the voice assistant unit 242 without determining the verification score and comparing the verification score with the verification threshold. Further, in the illustrated embodiment, the processes for determining and comparing the keyword score are described as being performed before the processes for determining and comparing the verification score. However, the processes for the keyword score may be performed after the processes for the verification score, or concurrently with the processes for the verification score.

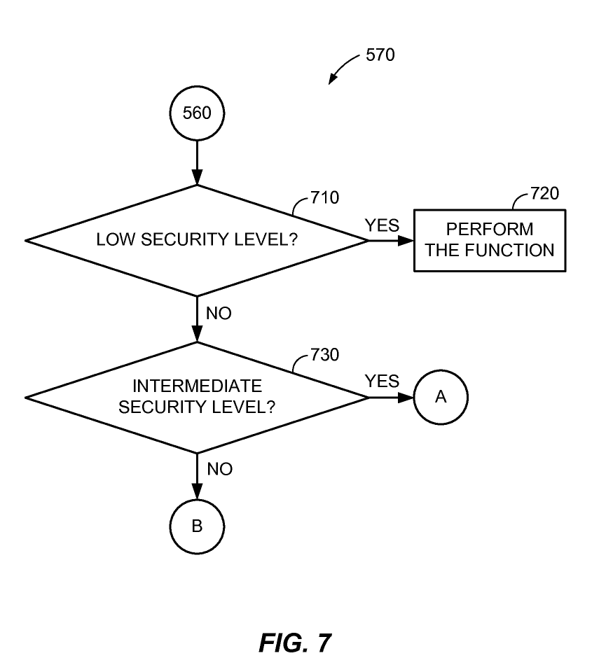

FIG. 7 illustrates a flowchart of a detailed method of 570 for performing the function associated with the speech command according to the security level associated with the speech command, according to one embodiment of the present disclosure. When the security level associated with the speech command is determined, at 560, the voice assistant unit 242 may determine whether the determined security level is a low security level which does not require speaker verification, at 710. If the determined security level is the low security level (i.e., YES at 710), the method may proceed to 720 to perform the function.

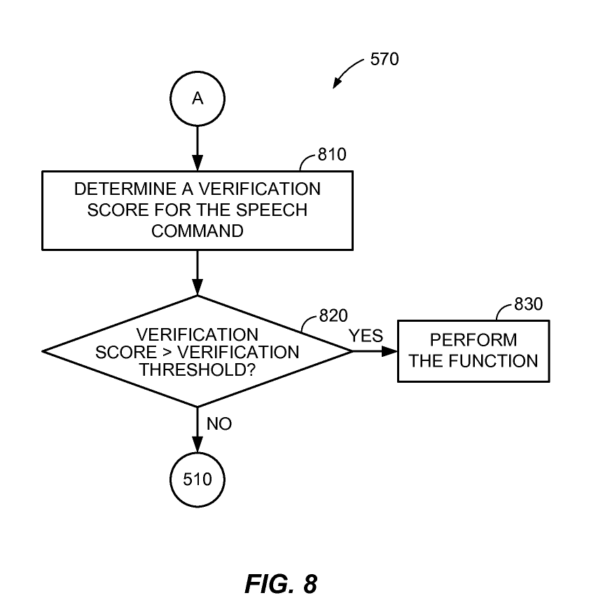

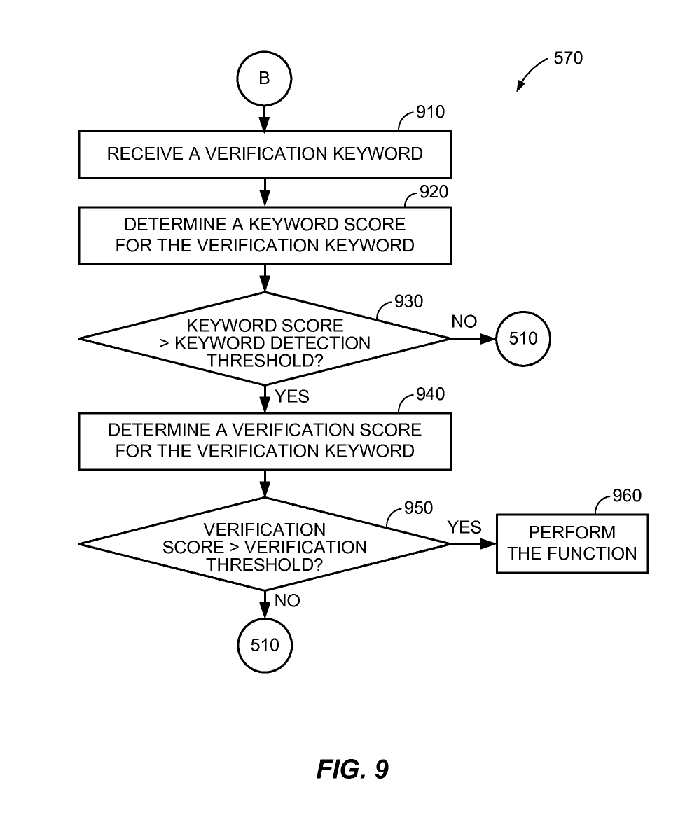

On the other hand, if the determined security level is not the low security level (i.e., NO at 710), the method may proceed to 730 to determine whether the determined security level is an intermediate security level which requires speaker verification. In the case of the intermediate security level (i.e., YES at 730), the method proceeds to 810 in FIG. 8 to verify whether the speaker of the speech command is an authorized user. On the other hand, if the determined security level is not the intermediate security level (i.e., NO at 730), it may be inferred that the determined security level is a high security level which may request the speaker to input a verification keyword for verifying the speaker. In this case, the method may proceed to 910 in FIG. 9.

FIG. 8 illustrates a flowchart of a detailed method of 570 for performing the function in the electronic device 200 when the security level associated with the speech command is determined to be the intermediate security level, according to one embodiment of the present disclosure. As described above, the intermediate security level may require that a speaker of the speech command be a user authorized to perform the function associated with the speech command. When the security level associated with the speech command is determined to be the intermediate security level in FIG. 7 (i.e., YES at 720), the method proceeds to 810 to determine a verification score for the speech command.

According to one embodiment, the verification score determining unit 420 in the voice assistant unit 242 may extract one or more sound features from a received portion of the input sound stream that includes the speech command. The verification score is determined based on the extracted sound features and a speaker model for the speech command stored in the speaker model database 264. In this embodiment, the speaker model for the speech command may be generated based on a plurality of sound samples spoken by the authorized user. For example, the speaker model may be a text-independent model that is indicative of the authorized user. Additionally, the sound samples may be a set of words, phrases, sentences, or the like, which are phonetically balanced. In some embodiments, the speaker model may be a GMM model including statistical data such as a mean and a variance for the sound samples. Further, the speaker model may also include a maximum value, a minimum value, a noise power, an SNR, a signal power, an entropy, a kurtosis, a high order momentum, etc. of the sound samples. The verification score determining unit 420 may provide the verification score for the speech command to the security management unit 430.

Upon receiving the verification score from the verification score determining unit 420, the security management unit 430 may determine whether or not the verification score exceeds a verification threshold associated with the intermediate security level, at 820. In some embodiments, the security database 266 may include the verification threshold associated with the intermediate security level. If the verification score is determined to exceed the verification threshold (i.e., YES at 820), the method may proceed to 830 to perform the function associated with the speech command. On the other hand, if the verification score is determined not to exceed the verification threshold (i.e., NO at 820), the method may proceed to 510 in FIG. 5 to receive a next input sound stream.

According to one embodiment, a verification score for the activation keyword may be determined based on a speaker model. The speaker model for use in determining the verification score may be a text-dependent model that is generated for the activation keyword. Alternatively or additionally, a text-independent model may also be used as the speaker model for use in determining the verification score for the activation keyword. In this case, the text-independent model may be generated based on a plurality of sound samples spoken by the authorized user. If the verification score for the activation keyword exceeds a verification threshold, the method may proceed to perform the function. According to another embodiment, if at least one of the verification scores for the activation keyword and the speech command exceeds a verification threshold, the method may proceed to perform the function.

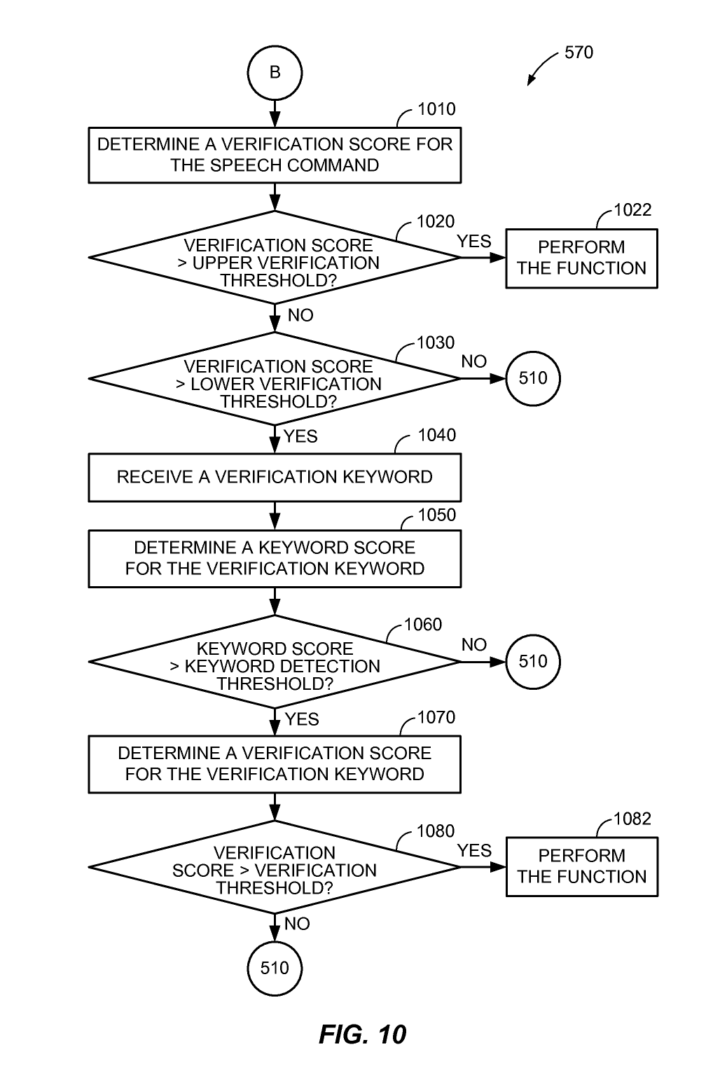

FIG. 9 illustrates a flowchart of a detailed method of 570 for performing the function in the electronic device 200 when the security level associated with the speech command is determined to be the high security level, according to one embodiment of the present disclosure. As described above, the high security level may request a speaker of the speech command to input a verification keyword to verify the speaker. When the security level associated with the speech command is determined not to be the intermediate security level (i.e., to be the high security level) in FIG. 7 (i.e., NO at 730), the method proceeds to 910 to receive a verification keyword from the speaker. As such, in the case of the high security level, the speaker of the speech command may be requested to input a verification keyword to the electronic device 200 regardless of a confidence level of the speech command for verifying the speaker to be an authorized user, as will be described below in detail with reference to FIG. 10.

Upon receiving the verification keyword (or the input sound stream), the voice assistant unit 242 may determine a keyword score for the verification keyword, at 920. In some embodiments, the voice assistant unit 242 may extract a plurality of sound features from the received portion of the input sound stream. A plurality of keyword scores may then be determined for the plurality of sound features, respectively, by using any suitable probability models such as a GMM, a neural network, an SVM, and the like.

The voice assistant unit 242 may compare each of the keyword scores with a predetermined keyword detection threshold for the verification keyword, at 930. In one embodiment, the security database 266 of the storage unit 260 may include the keyword detection threshold for the verification keyword. If none of the keyword scores for the verification keyword is determined not to exceed the keyword detection threshold for the verification keyword (i.e., NO at 930), the method may proceed to 510 in FIG. 5 to receive a next input sound stream.

On the other hand, if any keyword score for the verification keyword is determined to exceed the keyword detection threshold for the verification keyword (i.e., YES at 930), the method proceeds to 940 to determine a verification score for the verification keyword. In one embodiment, the verification score for the verification keyword may be determined based on the extracted sound features and a speaker model stored in the speaker model database 264. In this embodiment, the speaker model may be generated based on a plurality of sound samples of the verification keyword spoken by the authorized user. For example, the speaker model may be a text-dependent model that is generated for a predetermined verification keyword. According to some embodiments, the speaker model may be a GMM model including statistical data such as a mean and a variance for the sound samples. Further, the speaker model may also include a maximum value, a minimum value, a noise power, an SNR, a signal power, an entropy, a kurtosis, a high order momentum, etc. of the sound samples.

The verification score for the verification keyword may be compared with a verification threshold for the verification keyword, at 950. In some embodiments, the security database 266 may include the verification threshold for the verification keyword. If the verification score is determined to exceed the verification threshold (i.e., YES at 950), the method may proceed to 960 to perform the function associated with the speech command. On the other hand, if the verification score is determined not to exceed the verification threshold (i.e., NO at 950), the method may proceed to 510 in FIG. 5 to receive a next input sound stream. Although the processes for determining and comparing the keyword score for the verification keyword are described as being performed before the processes for determining and comparing the verification score for the verification keyword, the processes for the keyword score may be performed after the processes for the verification score, or concurrently with the processes for the verification score.

FIG. 10 illustrates a flowchart of a detailed method of 570 for performing the function in the electronic device 200 based on upper and lower verification thresholds for the speech command when the security level associated with the speech command is determined to be the high security level, according to one embodiment of the present disclosure. In this embodiment, when the security level associated with the speech command is determined not to be the intermediate security level (i.e., to be the high security level) in FIG. 7 (i.e., NO at 730), the method proceeds to 1010 to determine a verification score for the speech command, and the verification score is compared with an upper verification threshold associated with the high security level, at 1020, in a similar manner as described with reference to 810 and 820 in FIG. 8. If the verification score for the speech command is determined to exceed the upper verification threshold (i.e., YES at 1020), the method may proceed to 1022 to perform the function associated with the speech command.

On the other hand, if the verification score for the speech command is determined not to exceed the upper verification threshold (i.e., NO at 1020), the verification score for the speech command is compared with a lower verification threshold associated with the high security level, at 1030. If the verification score for the speech command is determined not to exceed the lower verification threshold (i.e., NO at 1030), the method may proceed to 510 in FIG. 5 to receive a next input sound stream. If the verification score for the speech command is determined to exceed the lower verification threshold (i.e., YES at 1030), the voice assistant unit 242 may request the speaker of the speech command to input a verification keyword. The electronic device 200 may receive the verification keyword spoken by the speaker, at 1040. In one embodiment, the electronic device 200 may receive an input sound stream including the verification keyword.

Once the verification keyword is received, at 1040, the voice assistant unit 242 may determine a keyword score for the verification keyword, at 1050. The keyword score may be determined using any suitable methods as described above. The voice assistant unit 242 may compare the keyword score for the verification keyword with a keyword detection threshold for the verification keyword, at 1060, and if the keyword score is determined not to exceed the keyword detection threshold for the verification keyword (i.e., NO at 1060), the method may proceed to 510 in FIG. 5 to receive a next input sound stream.

On the other hand, if the keyword score for the verification keyword is determined to exceed the keyword detection threshold for the verification keyword (i.e., YES at 1060), the method proceeds to 1070 to determine a verification score for the verification keyword based on a speaker model. In one embodiment, the speaker model may be generated based on a plurality of sound samples of the verification keyword spoken by an authorized user. The verification score for the verification keyword may be compared with a verification threshold for the verification keyword, at 1080. If the verification score is determined to exceed the verification threshold (i.e., YES at 1080), the method may proceed to 1082 to perform the function associated with the speech command. On the other hand, if the verification score is determined not to exceed the verification threshold (i.e., NO at 1080), the method may proceed to 510 in FIG. 5 to receive a next input sound stream. The processes for determining and comparing the keyword score and the verification score for the verification keyword from 1040 to 1082 may be performed in the same or similar manner to the processes determining and comparing the keyword score and the verification score for the verification keyword from 910 to 960 in FIG. 9.

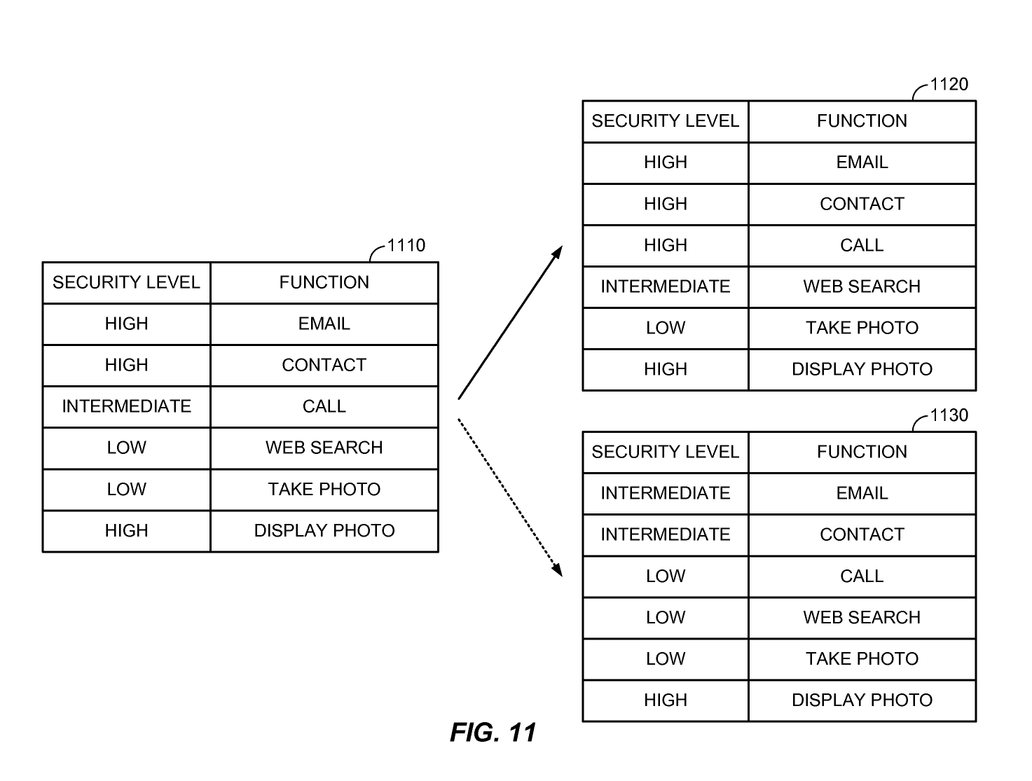

FIG. 11 illustrates a plurality of lookup tables 1110, 1120, and 1130, in which a plurality of security levels associated with a plurality of functions is adjusted in response to changing a device security level for the electronic device 200, according to one embodiment of the present disclosure. As described above with reference to FIG. 2, the storage unit 260 in the electronic device 200 may store the lookup tables 1110, 1120, and 1130 that map a plurality of functions to a plurality of security levels. The stored lookup tables 1110, 1120, and 1130 may be accessed to determine a security level associated with a function which is recognized from a speech command in an input sound stream.

In this embodiment, the device security level may be associated with assignment information indicating which security level is assigned to each function. The information may be predetermined by a manufacturer or user of the electronic device 200. Thus, as a current device security level is changed (e.g., raised or lowered) into a new device security level, the security levels of one or more functions may also be changed based on the new device security level.

As illustrated, the electronic device 200 may include a plurality of functions such as a function associated with an email application, a function associated with a contact application, a function associated with a call application, a function for performing web search, a function for taking a photo, a function for displaying stored photos, and the like. Each of the above functions may be initially assigned a high, intermediate, or low security level as indicated in the lookup table 1110. The security levels in the lookup table 1110 may be assigned based on a current device security level (e.g., an intermediate device security level), or individually assigned based on inputs from a user of the electronic device 200.

If the current device security level is changed to a higher device security level as indicated by a solid arrow in FIG. 11, the security levels of one or more functions may be changed based on the assignment information associated with the higher device security level. In this case, the assignment information may indicate which security level is assigned to each function in the higher device security level. Thus, the security level of the function associated with the call application may be changed from the intermediate security level to the high security level, and the function for performing web search may be changed from the low security level to the intermediate security level, as indicated in the lookup table 1120.

On the other hand, if the current device security level is changed to a lower device security level as indicated by a dashed arrow, the security levels of one or more functions may be changed based on the assignment information associated with the lower security level. In this case, the assignment information may indicate which security level is assigned to each function in the lower device security level. Thus, the security levels of the functions associated with the email application and the contact application may be changed from the high security level to the intermediate security level, as indicated in the lookup table 1130. Also, the function associated with the call application may be changed from the intermediate security level to the low security level, as indicated in the lookup table 1130. Although FIG. 11 describes the information for mapping the security levels to the associated functions as being stored and processed in the form of a lookup table, such information may be in any other suitable form of a data structure, database, etc.

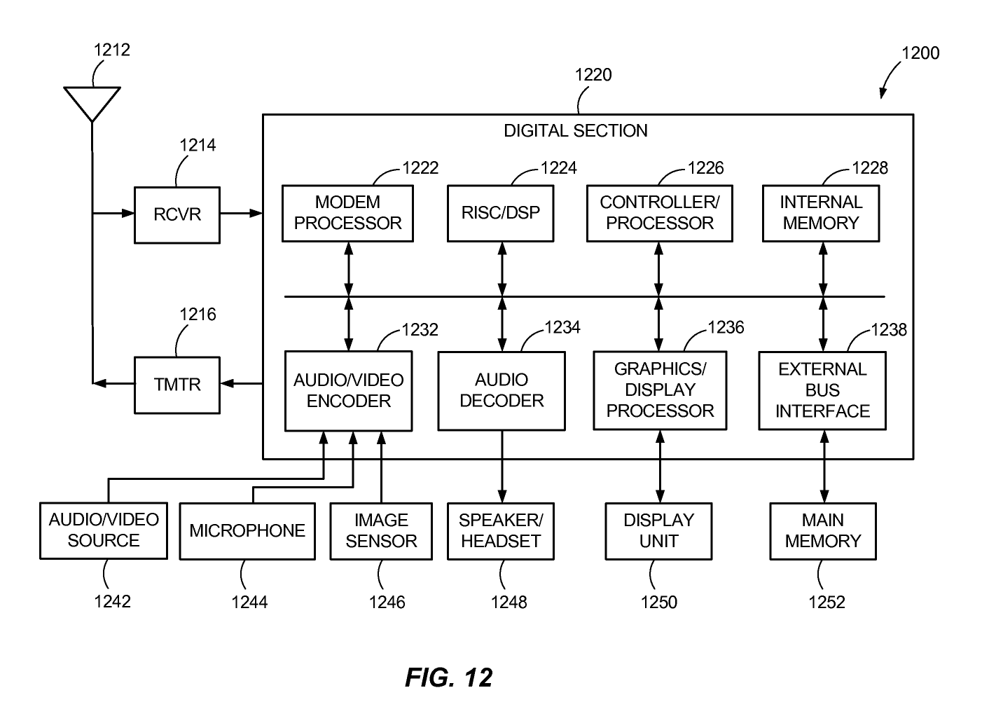

FIG. 12 is a block diagram of an exemplary electronic device 1200 in which the methods and apparatus for performing a function of a voice assistant unit in response to an activation keyword and a speech command in an input sound stream may be implemented according to some embodiments of the present disclosure. The configuration of the electronic device 1200 may be implemented in the electronic devices according to the above embodiments described with reference to FIGS. 1 to 11. The electronic device 1200 may be a cellular phone, a smartphone, a tablet computer, a laptop computer, a terminal, a handset, a personal digital assistant (PDA), a wireless modem, a cordless phone, etc. The wireless communication system may be a Code Division Multiple Access (CDMA) system, a Broadcast System for Mobile Communications (GSM) system, Wideband CDMA (WCDMA) system, Long Tern Evolution (LTE) system, LTE Advanced system, etc. Further, the electronic device 1200 may communicate directly with another mobile device, e.g., using Wi-Fi Direct or Bluetooth.

The electronic device 1200 is capable of providing bidirectional communication via a receive path and a transmit path. On the receive path, signals transmitted by base stations are received by an antenna 1212 and are provided to a receiver (RCVR) 1214. The receiver 1214 conditions and digitizes the received signal and provides samples such as the conditioned and digitized digital signal to a digital section for further processing. On the transmit path, a transmitter (TMTR) 1216 receives data to be transmitted from a digital section 1220, processes and conditions the data, and generates a modulated signal, which is transmitted via the antenna 1212 to the base stations. The receiver 1214 and the transmitter 1216 may be part of a transceiver that may support CDMA, GSM, LTE, LTE Advanced, etc.

The digital section 1220 includes various processing, interface, and memory units such as, for example, a modem processor 1222, a reduced instruction set computer/digital signal processor (RISC/DSP) 1224, a controller/processor 1226, an internal memory 1228, a generalized audio/video encoder 1232, a generalized audio decoder 1234, a graphics/display processor 1236, and an external bus interface (EBI) 1238. The modem processor 1222 may perform processing for data transmission and reception, e.g., encoding, modulation, demodulation, and decoding. The RISC/DSP 1224 may perform general and specialized processing for the electronic device 1200. The controller/processor 1226 may perform the operation of various processing and interface units within the digital section 1220. The internal memory 1228 may store data and/or instructions for various units within the digital section 1220.

The generalized audio/video encoder 1232 may perform encoding for input signals from an audio/video source 1242, a microphone 1244, an image sensor 1246, etc. The generalized audio decoder 1234 may perform decoding for coded audio data and may provide output signals to a speaker/headset 1248. The graphics/display processor 1236 may perform processing for graphics, videos, images, and texts, which may be presented to a display unit 1250. The EBI 1238 may facilitate transfer of data between the digital section 1220 and a main memory 1252.

The digital section 1220 may be implemented with one or more processors, DSPs, microprocessors, RISCs, etc. The digital section 1220 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Further, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for performing a function in an electronic device, the method comprising:
receiving an input sound stream including a speech command indicative of the function;
identifying the function from the speech command in the input sound stream;
determining a security level associated with the speech command;
verifying whether the input sound stream is indicative of a user authorized to perform the function based on the security level; and
performing the function in response to verifying that the input sound stream is indicative of the user.

2. The method of claim 1, wherein the function is associated with the security level among a plurality of predetermined security levels.

3. The method of claim 2, wherein the plurality of predetermined security levels are assigned to a plurality of functions, and
wherein at least one of the plurality of predetermined security levels is adjusted in response to a change in a device security level.

4. The method of claim 1, wherein verifying whether the input sound stream is indicative of the user comprises verifying whether the speech command in the input sound stream is indicative of the user.

5. The method of claim 4, wherein verifying whether the speech command in the input sound stream is indicative of the user comprises:
determining a verification score for the speech command based on a speaker model associated with the user; and
verifying whether the speech command is indicative of the user based on the verification score for the speech command and a verification threshold associated with the security level.

6. The method of claim 1, wherein verifying whether the input sound stream is indicative of the user comprises:
receiving a verification keyword from a speaker of the speech command; and
verifying whether the verification keyword is indicative of the user.

7. The method of claim 6, wherein verifying whether the verification keyword is indicative of the user comprises:
determining a keyword score for the verification keyword; and
verifying whether the verification keyword is indicative of the user based on the keyword score and a keyword detection threshold.

8. The method of claim 6, wherein verifying whether the verification keyword is indicative of the user comprises:
determining a verification score for the verification keyword based on a speaker model associated with the verification keyword; and
verifying whether the verification keyword is indicative of the user based on the verification score for the verification keyword and a verification threshold associated with the verification keyword.

9. The method of claim 1, wherein receiving the input sound stream comprises receiving an activation keyword for activating a speech recognition application adapted to identify the function from the speech command, and
wherein the method further comprises:
verifying whether the activation keyword is indicative of an authorized user of the speech recognition application; and
activating the speech recognition application in response to verifying that the activation keyword is indicative of the authorized user of the speech recognition application.

10. The method of claim 1, wherein receiving the input sound stream comprises:
receiving an activation keyword for activating a speech recognition application adapted to identify the function from the speech command; and
detecting the activation keyword from the input sound stream to activate the speech recognition application, and
wherein verifying whether the input sound stream is indicative of the user comprises verifying whether at least one of the activation keyword and the speech command in the input sound stream is indicative of the user.

11. An electronic device for performing a function, comprising:
a sound sensor configured to receive an input sound stream including a speech command indicative of the function;
a speech recognition unit configured to identify the function from the speech command in the input sound stream;
a security management unit configured to verify whether the input sound stream is indicative of a user authorized to perform the function based on a security level associated with the speech command; and
a function control unit configured to perform the function in response to verifying that the input sound stream is indicative of the user.

12. The electronic device of claim 11, wherein the function is associated with the security level among a plurality of predetermined security levels.

13. The electronic device of claim 12, wherein the plurality of predetermined security levels are assigned to a plurality of functions, and
wherein at least one of the plurality of predetermined security levels is adjusted in response to a change in a device security level.

14. The electronic device of claim 11, wherein the security management unit is configured to verify whether the speech command in the input sound stream is indicative of the user.

15. The electronic device of claim 14, further comprising a verification score determining unit configured to determine a verification score for the speech command based on a speaker model associated with the user,
wherein the security management unit is configured to verify whether the speech command is indicative of the user based on the verification score for the speech command and a verification threshold associated with the security level.

16. The electronic device of claim 11, wherein the sound sensor is further configured to receive a verification keyword from a speaker of the speech command, and
wherein the security management unit is configured to verify whether the verification keyword is indicative of the user.

17. The electronic device of claim 16, wherein the speech recognition unit is further configured to:
determine a keyword score for the verification keyword; and
verify whether the verification keyword is indicative of the user based on the keyword score and a keyword detection threshold.

18. The electronic device of claim 16, further comprising a verification score determining unit configured to determine a verification score for the verification keyword based on a speaker model associated with the verification keyword,
wherein the security management unit is configured to verify whether the verification keyword is indicative of the user based on the verification score for the verification keyword and a verification threshold associated with the verification keyword.

19. The electronic device of claim 11, wherein the sound sensor is further configured to receive an activation keyword for activating the speech recognition unit adapted to identify the function from the speech command, and
wherein the electronic device further comprises a voice activation unit configured to:
verify whether the activation keyword is indicative of an authorized user of the speech recognition unit; and
activate the speech recognition unit in response to verifying that the activation keyword is indicative of the authorized user of the speech recognition unit.

20. The electronic device of claim 11, wherein the sound sensor is further configured to receive an activation keyword for activating the speech recognition unit adapted to identify the function from the speech command, and
wherein the electronic device further comprises a voice activation unit configured to detect the activation keyword to activate the speech recognition unit, and
wherein the security management unit is configured to verify whether at least one of the activation keyword and the speech command is indicative of the user.

21. An electronic device for performing a function, comprising:
means for receiving an input sound stream including a speech command indicative of the function;
means for identifying the function from the speech command in the input sound stream;
means for verifying whether the input sound stream is indicative of a user authorized to perform the function based on a security level associated with the speech command; and
means for performing the function in response to verifying that the input sound stream is indicative of the user.

22. The electronic device of claim 21, wherein a plurality of predetermined security levels are assigned to a plurality of functions, the plurality of predetermined security levels including the security level associated with the speech command, and the plurality of functions including the function identified from the speech command, and
wherein at least one of the plurality of predetermined security levels is adjusted in response to a change in a device security level.

23. The electronic device of claim 21, wherein the means for verifying whether the input sound stream is indicative of the user is configured to verify whether the speech command in the input sound stream is indicative of the user.

24. The electronic device of claim 23, further comprising means for determining a verification score for the speech command based on a speaker model associated with the user,
wherein the means for verifying whether the input sound stream is indicative of the user is configured to verify whether the speech command is indicative of the user based on the verification score for the speech command and a verification threshold associated with the security level.

25. The electronic device of claim 21, wherein the means for receiving the input sound stream is further configured to receive a verification keyword from a speaker of the speech command, and
wherein the means for verifying whether the input sound stream is indicative of the user is configured to verify whether the verification keyword is indicative of the user.

26. A non-transitory computer-readable storage medium comprising instructions for performing a function, the instructions causing a processor of an electronic device to perform the operations of:
receiving an input sound stream including a speech command indicative of the function;
identifying the function from the speech command in the input sound stream;
determining a security level associated with the speech command;
verifying whether the input sound stream is indicative of a user authorized to perform the function based on the security level; and
performing the function in response to verifying that the input sound stream is indicative of the user.

27. The medium of claim 26, wherein a plurality of predetermined security levels are assigned to a plurality of functions, the plurality of predetermined security levels including the security level associated with the speech command, and the plurality of functions including the function identified from the speech command, and
wherein at least one of the plurality of predetermined security levels is adjusted in response to a change in a device security level.

28. The medium of claim 26, wherein verifying whether the input sound stream is indicative of the user comprises verifying whether the speech command in the input sound stream is indicative of the user.

29. The medium of claim 28, wherein verifying whether the speech command in the input sound stream is indicative of the user comprises:
determining a verification score for the speech command based on a speaker model associated with the user; and
verifying whether the speech command is indicative of the user based on the verification score for the speech command and a verification threshold associated with the security level.

30. The medium of claim 26, wherein verifying whether the input sound stream is indicative of the user comprises:
receiving a verification keyword from a speaker of the speech command; and
verifying whether the verification keyword is indicative of the user.
